(19) United States
(12) Patent Application Publication
(10) Pub. No.: US 2012/0016643 A1
(43) Pub. Date: Jan. 19, 2012

(54) VIRTUAL MEASURING SYSTEM AND METHOD FOR PREDICTING THE QUALITY OF THIN FILM TRANSISTOR LIQUID CRYSTAL DISPLAY PROCESSES

(75) Inventors: SHI-SHANG JANG, Hsinchu CIty (TW); TAIN-HONG PAN, Jiangsu (CN); SHAN-HILL WONG, Hsinchu City (TW)

(73) Assignee: NATIONAL TSING HUA UNIVERSITY, Hsinchu City (TW)

(21) Appl. No.: 12/915,397

(22) Filed: Oct. 29, 2010

(30) Foreign Application Priority Data
Jul. 16, 2010 (TW) 099123591

(51) Int. Cl. G06F 17/10

(52) U.S. Cl. 703/2

(57) ABSTRACT

The present invention discloses a virtual measuring system and a method thereof for predicting the quality of thin film transistor liquid crystal display processes. The virtual measuring method comprises the steps of: capturing a plurality of process parameter data from at least one process machine by an advanced process control unit; normalizing the process parameter data by an original data processing unit; picking a plurality of key process parameter data from the process parameter data by a key parameter choosing unit; establishing a virtual measuring model by a predicting unit according to the key process parameter data, and generating a virtual measuring data by the virtual measuring model. The virtual measuring model is established after a disturbing coefficient is generated through a time sequence regression algorithm by the predicting unit.

### BACKGROUND OF THE INVENTION

1. Field of the Invention

The present invention relates to a virtual measuring system and a virtual measuring method for predicting the quality of thin film transistor liquid crystal display processes, and more particularly to a virtual measuring system and a virtual measuring method applied for LCD etching processes.

2. Description of the Related Art

At present, an etching process performed in a front-end process of LCD generally masks a desired portion of a thin film by a photoresist, and then exposes and develops the thin film, and finally uses a physical or chemical method to remove the unwanted portion to form a desired pattern. The etching process is mainly divided into wet etching and dry etching according to different etching precisions, etching measures and etching effects. The dry etching includes plasma etching and reactive ion etching, and the wet etching uses various different chemical solutions to perform a chemical reaction with the exposed thin film to achieve the etching effect. The quality of the etching technology depends on the size of circuit, and thus after the etching process is completed, an etching post-inspection is performed to determine whether or not there is any change occurred in the etching process.

Based on the consideration of costs, the inspection of most production machines for manufacturing thin film transistor light emitting diodes (TFT-LCD) adopts a random sampling inspection. In other words, 7˜8 panels of the same specification are randomly sampled daily to monitor a stable production quality and determine the product quality. However, if there is any problem in the process of manufacturing the panels, the problem is usually discovered at the time when the inspection takes place, but the problematic machine has manufactured many defective products already. There is a time lag from the occurrence of a change of operation variables of the process to the occurrence of a quality problem, and thus it is one of the major problems for panel manufacturers to discover the quality problem of products within the shortest time.

On the other hand, most production lines manufacture products of various different specifications at the same time to improve the productivity of the machines. However, a normal random sampling and measuring method randomly samples one product only, and thus it is also a major problem for panel manufacturers to reduce the sampling inspection cost and improve the random inspection efficiency.

Virtual metrology is one of the main technological measures to overcome the aforementioned problems, and its fundamental concept is to use a large quantity of predicting variables such as advanced process control data (APC) measurable online to predict the quality of manufacturing products, so as to facilitate the timely discovery of abnormality of the production machines when it occurs, and identify the defective products to save energy sources for later processes and improve the production yield rate.

However, the advanced process control system involves a huge number of data, and some key variables are highly correlated, and the traditional way of handling these problems is to adopt statistical regression methods, and the most common ones are the principal component regression (PCR) method and the partial least squares (PLS) method. As to the PCR/PLS methods, a data compression is generally used to replace the original variables. As a result, field engineers are unable to understand the effect of each variable to the product quality and cannot find the key factors for the change. To better understand or control the system, it is very advantageous to use variables with a physical significance to establish a model and these variables with the physical significance are valuable references to the diagnostics of system failure and the improvement of the operation efficiency of the system.

In addition, there are many unpredictable variables in the panel manufacturing process, such as the etching process of the TFT-LCD, the actual consumption of the etching solution, and the ion concentration of the etching solution which cannot be measured accurately. However, these variables have direct effect on the final line width of the products etched by the etching process, so that these actors must be taken into consideration in the virtual measuring system to improve the precision of the prediction.

Some patented technologies applied in the semiconductor field are described as follows. Taiwan Pat. Application No. 093115993 entitled “System for predicting quality of production processes and method thereof” discloses a method that uses the characteristics of a machine to select the corresponding prediction mode and predicts the product quality. However, this method has a limitation of making adjustment, maintenance or repair and fails to reflect which variables in the batch process are key variables.

Taiwan Pat. Application No. 095120601 entitled “Virtual measuring prediction method and system applied for quality control of semiconductor manufacture” discloses a method that sets a wafer sampling frequency and corrects a control chart according to a residual difference between the actual measured value and an estimated value to determine the next action taken. Although this method can reflect the change of a machine, yet it cannot reflect the source for the change of the machine. Furthermore, this method has a high misjudgment rate when there is a disturbance.

Taiwan Pat. Application No. 094121585 entitled “Instant predicting and measuring system, method for integrating process information of the instant predicting and measuring system and method for predicting at least one output in a virtual measuring tool” discloses a structure of an instant predicting and measuring system, and this structure requires each information system to have at least one output variable related to the process, but does not allow any use of an appropriate input variable according to the characteristics of different equipments.

U.S. Pat. No. 6,616,759 entitled “Method of monitoring and/or controlling a semiconductor manufacturing apparatus and system thereof” and applied in a semiconductor manufacturing process discloses a method of calculating a new parameter setting of a process based on a PLS method. However, this method does not let field engineers understand the effect of each variable to the product quality easily.

U.S. Pat. No. 6,666,577 entitled “Method for predicting temperature, test wafer for use in temperature prediction and method for evaluating lamp heating system” and discloses a method for predicting the temperature of a semiconductor wafer process, but this method is applicable for specific types of machines only and lacks of universality.

### SUMMARY OF THE INVENTION

In view of the aforementioned shortcomings of the prior art, it is a primary objective of the invention to provide a virtual measuring system and a virtual measuring method for predicting the quality of thin film transistor liquid crystal display processes to overcome the problems of a conventional virtual measuring method that uses a data compression to replace original variables and fails to let field engineers understand the effect of each variable to the product quality or fails to locate the key factor of the occurrence of a change.

To achieve the foregoing objectives, the present invention provides a virtual measuring method for predicting the quality of thin film transistor liquid crystal display processes, and the method comprises the steps of: capturing a plurality of process parameter data of at least one process machine by an advanced process control unit; normalizing the plurality of process parameter data by an original data processing unit; picking a plurality of key process parameter data from the plurality of process parameter data by a key parameter choosing unit; and establishing a virtual measuring model according to the plurality of key process parameter data by a predicting unit, and generating a virtual measuring datum by the virtual measuring model; wherein the predicting unit establishes the virtual measuring model after a disturbing coefficient is generated by a time sequence regression algorithm.

The original data processing unit subtracts an average of the process parameter data value from each process parameter datum and divides the result by a standard deviation of the process parameter data.

The key parameter choosing unit picks a key process parameter datum from the process parameter data by a stepwise regression method, and if a partial F value of one of the process parameter data is greater than an entry threshold value, then the process parameter datum will be set as the key process parameter datum, and if the partial F value of one of the process parameter data is smaller than an elimination threshold value, then the process parameter datum will not be set as one of the key process parameter data.

The key parameter choosing unit generates an initial model by a linear least squares algorithm according to the key process parameter datum and the plurality of actual measured values, and the initial model generates a plurality of estimated values.

The predicting unit establishes a virtual measuring model after a disturbing coefficient is generated by a time sequence regression algorithm according to a plurality of errors between the estimated value and an actual measured value corresponding to each estimated value.

To achieve the forgoing objectives, the present invention further provides a virtual measuring system for predicting the quality of thin film transistor liquid crystal display processes, and the system comprises an advanced process control unit, an original data processing unit, a key parameter choosing unit and a predicting unit. The advanced process control unit captures a plurality of process parameter data of at least one process machine; the original data processing unit normalizes the process parameter data; the key parameter choosing unit picks a plurality of key process parameter data from the process parameter data; the predicting unit establishes a virtual measuring model according to the key process parameter data; and the virtual measuring model generates a virtual measuring data. The predicting unit establishes a virtual measuring model after a disturbing coefficient is generated by a time sequence regression algorithm.

The original data processing unit subtracts an average value of the process parameter data from each process parameter datum, and divides the result by a standard deviation of the process parameter data.

The key parameter choosing unit picks a key process parameter datum from the process parameter data by a stepwise regression method, and if a partial F value of one of the process parameter data is greater than an entry threshold value, then the process parameter datum will be set as the key process parameter datum, and if the partial F value of one of the process parameter data is smaller than an elimination threshold value, then the process parameter datum will not be set as one of the key process parameter data.

The key parameter choosing unit further generates an initial model by a linear least squares algorithm according to the key process parameter datum and the plurality of actual measured values, and the initial model generates a plurality of estimated values.

The predicting unit generates a virtual measuring model after a disturbing coefficient is generated by a time sequence regression algorithm according to a plurality of errors between the estimated value and an actual measured value corresponding to each estimated value.

According to the description above, the virtual measuring system and the method thereof for predicting the quality of thin film transistor liquid crystal display processes in accordance with the present invention have one or more of the following advantages:

(1) The virtual measuring system and the method thereof for predicting the quality of thin film transistor liquid crystal display processes can pick the key process parameter by the stepwise regression method to establish the virtual measuring model to improve the field engineer's understanding about the effect of the process parameters to the product quality.

(2) The virtual measuring system and the method thereof for predicting the quality of thin film transistor liquid crystal display processes can establish the virtual measuring model by the ANCOVA technology, such that the quality of various products with the same process recipe and different specifications can be predicted.

(3) The virtual measuring system and the method thereof for predicting the quality of thin film transistor liquid crystal display processes can compensate the effect of unpredictable parameters to the product quality by the time sequence technology.

### BRIEF DESCRIPTION OF THE DRAWINGS

FIG. 1 is a block diagram of a virtual measuring system for predicting the quality of thin film transistor liquid crystal display processes in accordance with the present invention;

FIG. 2 is a schematic view of picking key process parameter data in accordance with the present invention;

FIG. 3 is a schematic view of a virtual measuring system for predicting the quality of thin film transistor liquid crystal display processes in accordance with a preferred embodiment of the present invention;

FIG. 4 is a schematic view showing fitting results of a time sequence method in accordance with the present invention;

FIG. 5 is a schematic view showing virtual measured results of different products in accordance with the present invention;

FIG. 6 is another schematic view showing virtual measured results of different products in accordance with the present invention; and

FIG. 7 is a flow chart of a virtual measuring method for predicting the manufacturing result of thin film transistor liquid crystal display processes in accordance with the present invention.

### DETAILED DESCRIPTION OF THE PREFERRED EMBODIMENTS

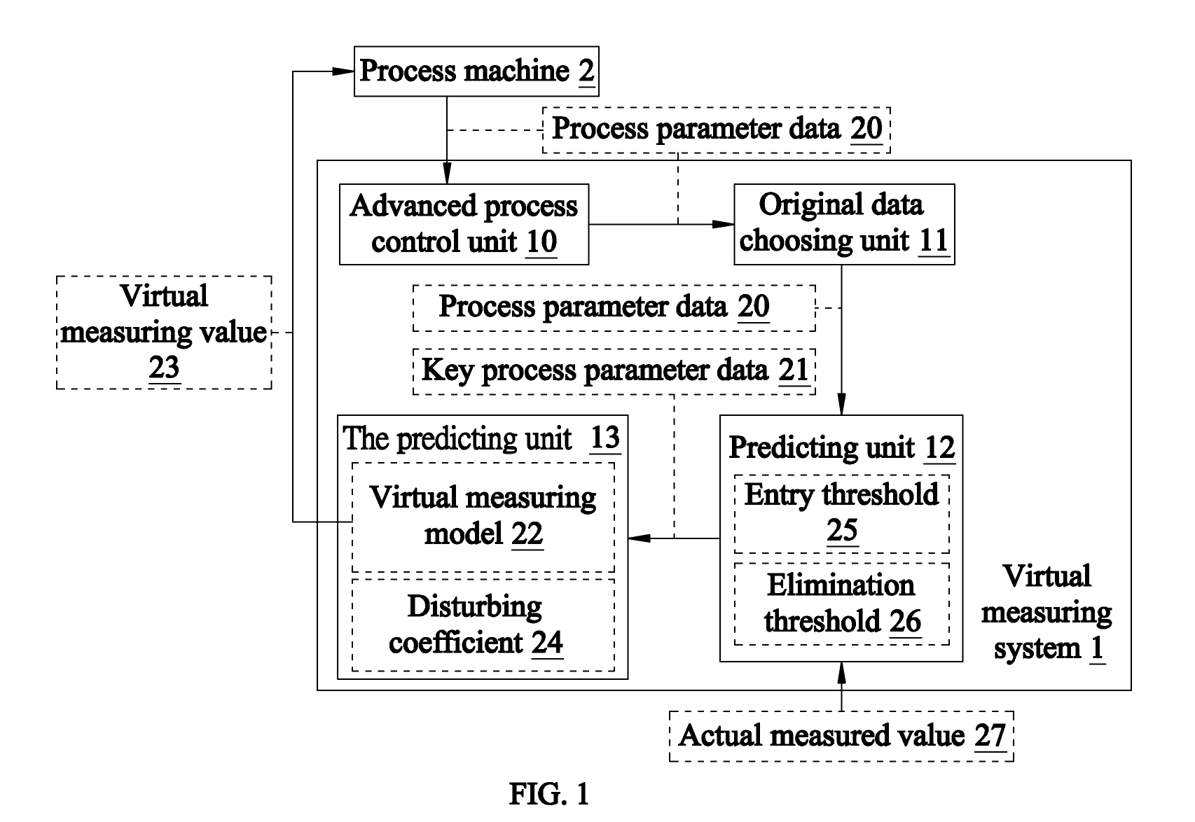

With reference to FIG. 1 for a block diagram of a virtual measuring system for predicting the quality of thin film transistor liquid crystal display processes in accordance with the present invention, the virtual measuring system 1 comprises an advanced process control unit 10, an original data processing unit 11, a key parameter choosing unit 12 and a predicting unit 13. The advanced process control unit 10 captures a plurality of process parameter data 20 of at least one process machine 2; the original data processing unit 11 normalizes the process parameter data 20; the key parameter choosing unit 12 picks a plurality of key process parameter data 21 from the process parameter data 20; the predicting unit 13 establishes a virtual measuring model 22 according to the key process parameter data 21; and the virtual measuring model 22 generates a virtual measuring datum 23. The predicting unit 13 establishes a virtual measuring model 22 after using a time sequence regression algorithm to generate a disturbing coefficient 24.

The original data processing unit 11 subtracts an average value of the process parameter data 20 from each process parameter datum 20, and then divides the result by a standard deviation of the process parameter data 20. The key parameter choosing unit 12 picks a key process parameter datum 21 from the process parameter data 20 by a stepwise regression method, and if a partial F value of one of the process parameter data 20 is greater than an entry threshold value 25, then the process parameter datum 20 will be set as one of the key process parameter data 21, and if the partial F value of one of the process parameter data 20 is smaller than an elimination threshold value 26, then the process parameter datum 20 will not be set as one of the key process parameter data 21. In addition, the key parameter choosing unit 12 further generates an initial model according to the key process parameter datum 21 and the plurality of actual measured values 27 by a linear least squares algorithm, and the initial model generates a plurality of estimated values. The predicting unit 13 corrects the initial model to the virtual measuring model 22 after the disturbing coefficient 24 is generated by the time sequence regression algorithm according to the plurality of errors between the estimated value and the actual measured value 27 corresponding to each estimated value.

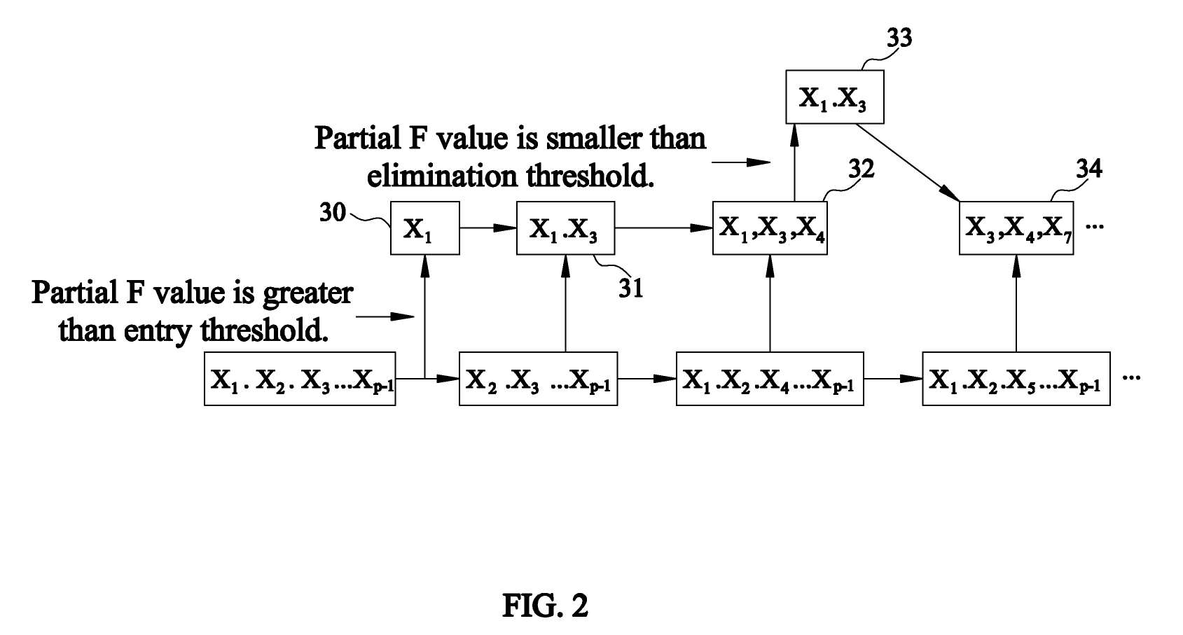

With reference to FIG. 2 for a schematic view of picking key process parameter data in accordance with the present invention, process parameter data with the most contribution to the final line width are selected from all process parameter data and added into the model at the beginning of the process of picking the key process parameter data in accordance with the present invention to produce a first model 30 as shown in FIG. 2. The remaining process parameter data are added into the first model 30 one by one, and a partial F value is calculated to make sure that the process parameter data has a contribution to the model (or is greater than the entry threshold value), and then the process parameter datum with the most contribution is added into the model to form a second model 31 (wherein the first to fifth models are all initial models). If the number of process parameter data exceeds 3, it is necessary to eliminate some of the process parameter data. In other words, each process parameter datum is removed from the model to check whether or not the partial F value is smaller than elimination threshold value, and then the process parameter datum with the smallest partial F value is eliminated, and other process parameter data are added continuously. This process is repeated until a required number of process parameter data is reached, or this process is stopped if each of all remaining process parameter data added to the model is smaller than the entry threshold value.

The way of picking an appropriate process parameter datum from the process parameter data X₂, X₃, X₄ to enter into the first model 30 after the first process parameter datum X₁ is added to the first model 30 is described as follows. Assumed that the first model 30 can be represented by Equation (1):

y=α+β₁X₁+ε (1)

If the process parameter data X₂ is selected and added to the first model 30 to form a second model 31, then the second model 31 can be represented by Equation (2):

y=α+β₁X₁+β₂X₂+ε (2)

Now, the following equation is used for calculating a partial F value:

F₀=partial F value=[SSR(1)−SSR(2)]/MSE(1)

If F₀ (partial F value) is greater than the entry threshold value, then the process parameter data X₂ will be added, or else the process parameter data X₂ will not be added.

The method of calculating SSR and MSE is described in details as follows: Assumed that the model can be represented by:

Y=Xβ+ε

Therefore, the first model 31 complies with the following equation:

$$Y = ( \begin{matrix}{y}_{1} \\ ⋮ \\ {y}_{13}\end{matrix} ) , X = ( \begin{matrix}1 & {X}_{1 , 1} & {X}_{2 , 1} \\ ⋮ & ⋮ & ⋮ \\ 1 & {X}_{1 , 13} & {X}_{2 , 13}\end{matrix} ) , β = ( \begin{matrix}α \\ {β}_{1} \\ {β}_{2}\end{matrix} ) , and$$

$$\hat{β} = {( {X}^{′} X )}^{- 1} {X}^{′} Y \\ SSR = \hat{β} {X}^{′} Y \\ SSE = {Y}^{′} Y - \hat{β} {X}^{′} Y \\ MSE = \frac{SSE}{n - p}$$

Where, n is a number, and p is the number of row(s) of X.

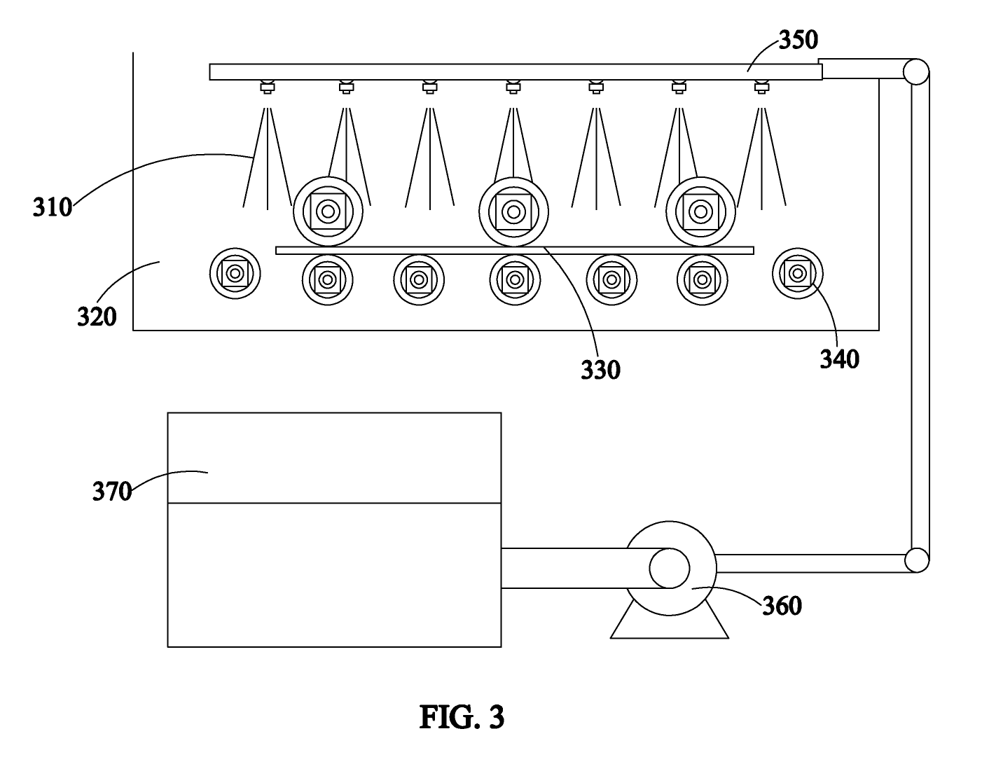

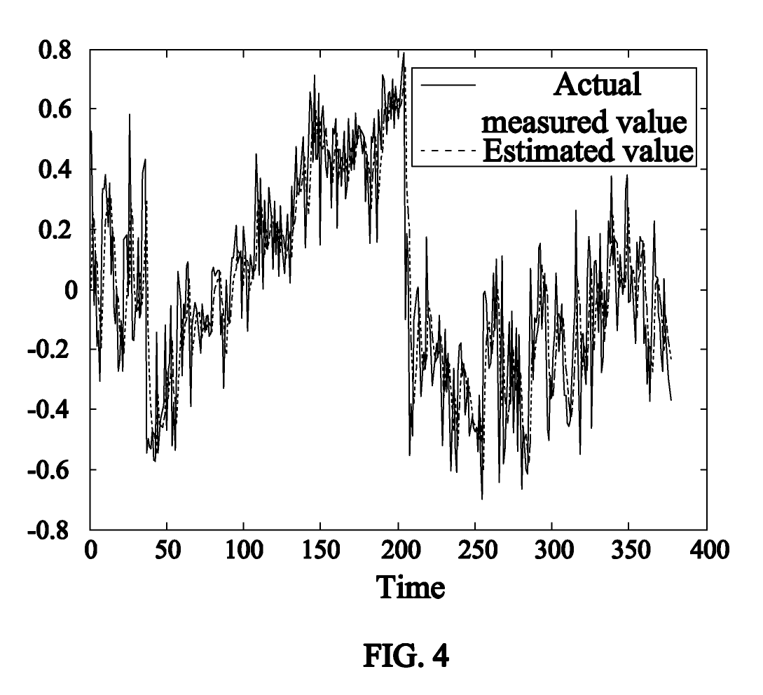

With reference to FIG. 3 for a schematic view of a virtual measuring system for predicting the quality of thin film transistor liquid crystal display processes in accordance with a preferred embodiment of the present invention, a wet etching process is shown. The virtual measuring system comprises an etching tank 320, an acid solution 310, a spray device 350, a liquid supply device 360, a storage tank 370, and a conveying device 340. A panel 330 is placed on the conveying device, and an acid solution from 39° C. to 44° C. is sprayed from a nozzle of the spray device 350 towards the panel 330, and the panel 330 is shaken sideway by the conveying device 340, such that the panel 330 is reacted with the acid solution 310 sufficiently, and atoms on a thin film surface are removed to achieve the etching effect. In FIG. 4, factors such as the etching effect, the etching time, the spraying pressure of the washing, the temperature of the acid solution, and the consumption process of the acid solution are correlated, wherein the etching time, the reaction temperature, the spraying pressure can be obtained directly from measurements by related instruments, but it is difficult to measure the consumption of the acid solution (which is the concentration of the instant reaction) directly.

In the virtual measuring system and the virtual measuring method for predicting the quality of thin film transistor liquid crystal display processes the present invention, an advanced process control unit is used for collecting information of sensors. The etching process includes 40 process parameters, and 10 of the process parameters have substantial effects on the width of the etching. In these 10 process parameters, the etching temperature and the flow rate of the etching solution are process parameters of most importance, and the rest of process parameters are used for process parameters for stabilizing the manufacturing process. The original data processing unit pre-processes all process parameters, and calculates the z scores for all sample values (x₁(k), x₂(k), . . . , x_{L}(k)) of each process parameter {xᵢ(k)}ₖ₌₁^{N}. In other words, the average (μ_{i,x}) is subtracted, and then divided by the standard deviation (σ_{i,x}) as shown in the following equation:

$${\hat{x}}_{i} ( k ) = \frac{{x}_{i} ( k ) - {μ}_{i , x}}{{σ}_{i , x}} ; i = 1 , 2 , … , L ; k = 1 , 2 , … , N$$

The key parameter choosing unit picks a key process parameter that affects the quality of sampled products by a stepwise regression method, and it sieves all predicted process parameters instead of using all process parameters for the prediction. The key parameter choosing unit checks the effect of the predicted process parameters one by one according to the level of interpretation capability, and a predicted process parameter having a contribution to the model is selected as the process parameter finally used by the model. Each step of selecting or eliminating a process parameter is based on a partial F value. If the partial F value of a certain process parameter is greater than an entry threshold value, then the process parameter is selected for the model, and if the partial F value of the process parameter is smaller than an elimination threshold value, then the process parameter will be eliminated from the model. In general, the entry threshold value is greater than or equal to the elimination threshold value. The key parameter choosing unit can be used for obtaining a key process parameter that affects the etching width of a panel 330:

{\tilde{x}ᵢ}ᵢ₌₁ⁿ(n<N)

The key parameter choosing unit takes the selected process parameter as an input process parameter, and the finally formed line width becomes an output process parameter, and a linear least squares algorithm is adopted to obtain a system model. It is noteworthy to point out that coefficients of the model must have physical significance. In other words, a constraint optimization equation is required:

$$min J = {( y ( k ) - {\sum }_{i = 1}^{n} {a}_{i} {\tilde{x}}_{i} ( k ) )}^{2}$$

$$s . t . {a}_{i} < 0$$

The ANCOVA technology is used for establishing a unified initial model for a plurality of products:

$$y ( k ) = μ + {\sum }_{i = 1}^{n} {a}_{i} {\tilde{x}}_{i} ( k ) + {τ}_{j}$$

$$s . t . {\sum }_{j = 1}^{m} {τ}_{j} = 0$$

An ANCOVA model is used for performing a model prediction to all inputted process parameters \tilde{x}ᵢ for establishing the model to obtain the following estimated values ŷ(k) in order to obtain a residual difference η(k) of the system:

η(k)=y(k)−ŷ(k)

A time sequence method is adopted to fit model parameters θ of IMA(1,1), and the fitted result is shown in FIG. 4, and finally the virtual measuring model is obtained:

$$y ( k ) = μ + {\sum }_{i = 1}^{n} {a}_{i} {\tilde{x}}_{i} ( k ) + {τ}_{j} + η ( k - 1 ) + ɛ ( k ) - θɛ ( k - 1 )$$

$$ɛ ( k ) = y ( k ) - \hat{y} ( k )$$

To overcome a disturbance of the system, it is necessary to adopt measurements with a fixed sampling frequency to update the error ε(k) of the system. At this point, it is not necessary to measure the line width of every product, but it simply needs to measure the line width of a certain product with the same process recipe to capture the current disturbance of the system. In this preferred embodiment, the mean square error (MSE) is applied to the evaluation index, and the related equation is given below:

$$MSE = \frac{1}{n} {\sum }_{i = 1}^{n} {( {y}_{i} - {\hat{y}}_{i} )}^{2}$$

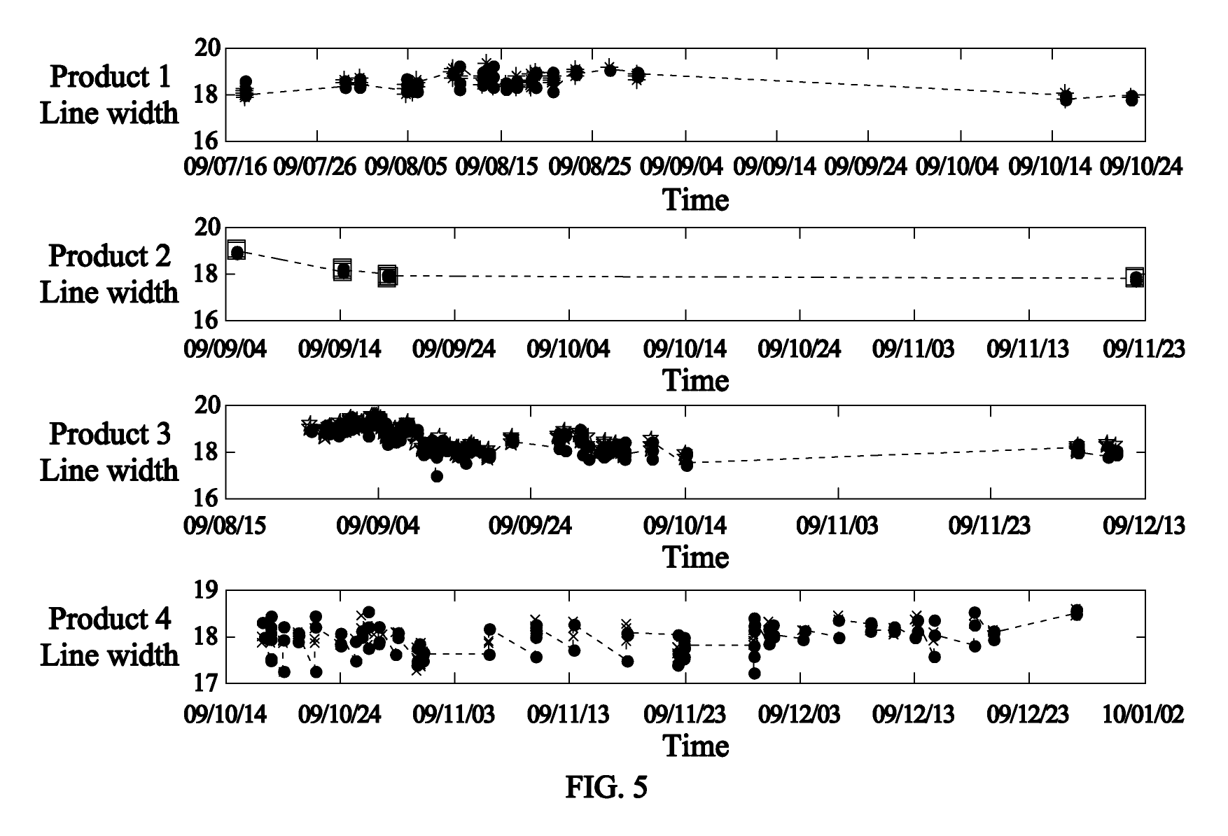

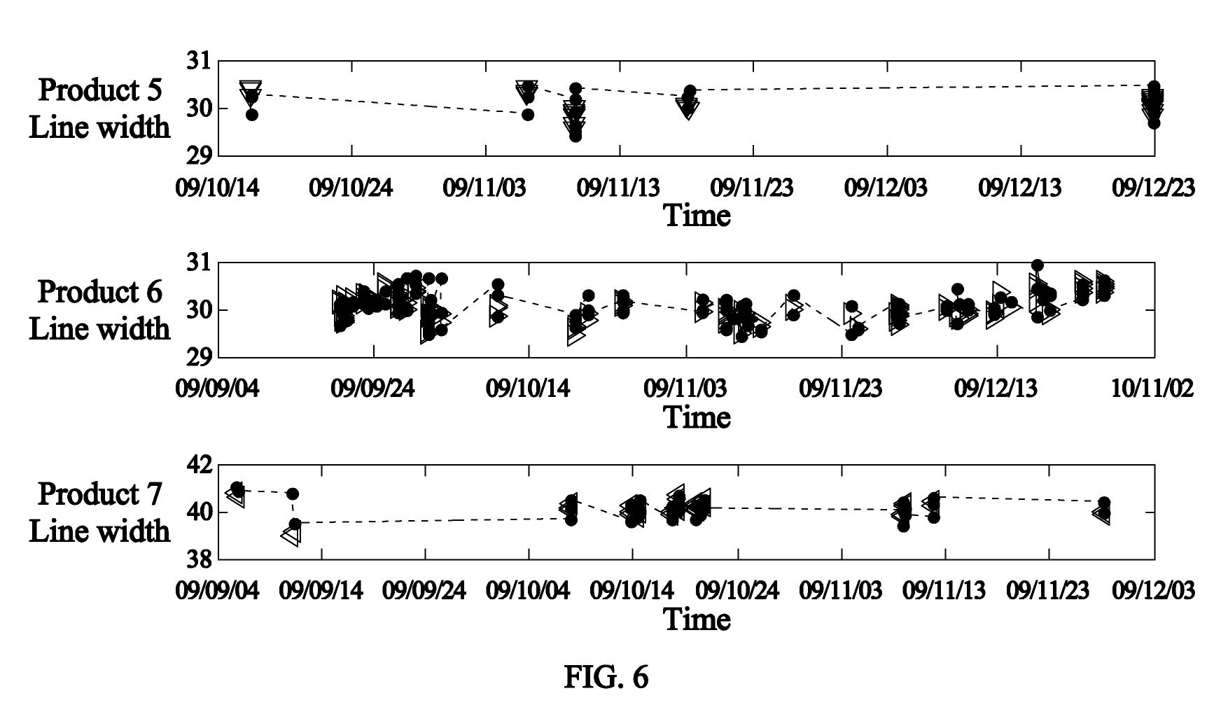

The method of the present invention gives a good result as shown in FIGS. 5 and 6, wherein the solid line in the figures indicates the actual measured value, and the dotted line indicates the virtual measuring data. The MSE of the model is 0.18, and the average R2 of the model is 80%, and these values show that that the variables have a good interpretation capability of the model.

In the process of describing the virtual measuring system for predicting the quality of thin film transistor liquid crystal display processes of the present invention, the concept of the virtual measuring method for predicting the quality of thin film transistor liquid crystal display processes is also disclosed. To make it easier for our examiner to understand the concept, we use a flow chart for the detailed description of the method in accordance with the invention.

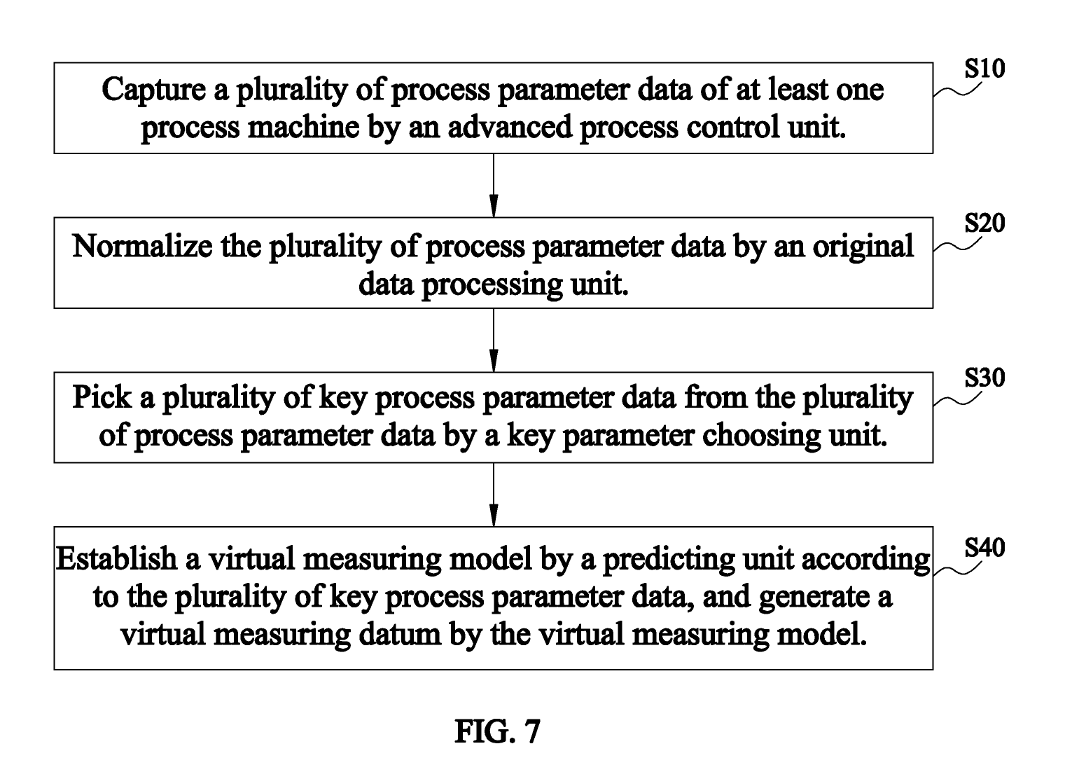

With reference to FIG. 7 for a flow chart for a virtual measuring method for predicting the quality of thin film transistor liquid crystal display processes in accordance with the present invention, the method comprises the steps of: (S10) capturing a plurality of process parameter data of at least one process machine by an advanced process control unit; (S20) normalizing the process parameter data by an original data processing unit; (S30) picking a plurality of key process parameter data from the process parameter data by a key parameter choosing unit; (S40) establishing a virtual measuring model by a predicting unit according to the key process parameter data, and using the virtual measuring model to generate a virtual measuring data. The predicting unit establishes a virtual measuring model after a time sequence regression algorithm generates a disturbing coefficient.

The implementation and effect of the virtual measuring method for predicting the quality of thin film transistor liquid crystal display processes in accordance with the present invention are mentioned in the description of the virtual measuring system and method for predicting the quality of thin film transistor liquid crystal display processes the present invention, and thus they will not be described here again.

The virtual measuring system and method for predicting the quality of thin film transistor liquid crystal display processes can pick a key process parameter by the stepwise regression to establish a virtual measuring model to improve the field engineer's understanding on the effect of the process parameters to the product quality, and use the analysis of covariance (ANCOVA) technology to establish the virtual measuring model to accurately measure the quality of various products with same process recipe and different specifications.

In summation of the description above, the present invention can improve over the prior art and comply with the patent application requirements, and thus the invention is duly filed for patent application. While the invention has been described by device of specific embodiments, numerous modifications and variations could be made thereto by those generally skilled in the art without departing from the scope and spirit of the invention set forth in the claims.

What is claimed is:

1. A virtual measuring method for predicting the quality of thin film transistor liquid crystal display processes, comprising the steps of:
capturing a plurality of process parameter data of at least one process machine by an advanced process control unit;
normalizing the plurality of process parameter data by an original data processing unit;
picking a plurality of key process parameter data from the plurality of process parameter data by a key parameter choosing unit; and
establishing a virtual measuring model according to the plurality of key process parameter data by a predicting unit, and generating a virtual measuring datum by the virtual measuring model; wherein the predicting unit establishes the virtual measuring model after a disturbing coefficient is generated by a time sequence regression algorithm.

2. The virtual measuring method of claim 1, wherein the original data processing unit subtracts an average value of the plurality of process parameter data from each process parameter datum, and then the result is divided by a standard deviation of the plurality of process parameter data.

3. The virtual measuring method of claim 1, wherein the key parameter choosing unit picks a plurality of key process parameter data from the plurality of process parameter data by a stepwise regression method, and if a partial F value of one of the plurality of process parameter data is greater than an entry threshold value, then the process parameter datum is set as one of the plurality of key process parameter data, and if the partial F value of one of the plurality of process parameter data is smaller than an elimination threshold value, then the process parameter datum is not set as one of the plurality of key process parameter data.

4. The virtual measuring method of claim 3, wherein the key parameter choosing unit generates a linear least squares algorithm to produce an initial model according to the plurality of key process parameter data and the plurality of actual measured values, and the initial model generates a plurality of estimated values.

5. The virtual measuring method of claim 3, wherein the predicting unit uses a plurality of errors between the plurality of estimated values and an actual measured value of each corresponding estimated value to establish the virtual measuring model after the time sequence regression algorithm generates the disturbing coefficient.

6. A virtual measuring system for predicting the quality of thin film transistor liquid crystal display processes, comprising:
an advanced process control unit, for capturing a plurality of process parameter data of at least one process machine;
an original data processing unit, for normalizing the plurality of process parameter data;
a key parameter choosing unit, for picking a plurality of key process parameter data from the plurality of process parameter data; and
a predicting unit, for establishing a virtual measuring model according to the plurality of key process parameter data, and generating a virtual measuring datum by the virtual measuring model;
wherein the predicting unit establishes the virtual measuring model after a time sequence regression algorithm generates a disturbing coefficient.

7. The virtual measuring system of claim 6, wherein the original data processing unit subtracts an average value of the plurality of process parameter data from each process parameter datum, and then the result is divided by a standard deviation of the plurality of process parameter data.

8. The virtual measuring system of claim 6, wherein the key parameter choosing unit picks the plurality of key process parameter data from the plurality of process parameter data by a stepwise regression method, and if a partial F value of one of the plurality of the process parameter data is greater than an entry threshold value, then the process parameter datum is set as one of the plurality of the key process parameter data, and if the partial F value of one of the plurality of the process parameter data is smaller than an elimination threshold value, then the process parameter datum will not be set as one of the key process parameter data.

9. The virtual measuring system of claim 8, wherein the key parameter choosing unit further generates an initial model according to the plurality of key process parameter data and the plurality of actual measured values by a linear least squares algorithm, and the initial model generates a plurality of estimated values.

10. The virtual measuring system of claim 8, wherein the predicting unit establishes the virtual measuring model after the time sequence regression algorithm generates the disturbing coefficient according to a plurality of errors between the plurality of estimated values and an actual measured value corresponding to each estimated value.
